(19) United States
(12) Patent Application Publication
(10) Pub. No.: US 2022/0032204 A1
(43) Pub. Date: Feb. 3, 2022

(54) POP-UP FIGURES

(71) Applicant: LovePop, Inc., Boston, MA (US)

(72) Inventors: Jozef Karpiel, Boston, MA (US); Dariush Nejad, Boston, MA (US); Melissa Otis, Boston, MA (US); Robin Rose, Boston, MA (US)

(73) Assignee: LovePop, Inc., Boston, MA (US)

(21) Appl. No.: 16/993,239

(22) Filed: Aug. 13, 2020

Related U.S. Application Data
(63) Continuation-in-part of application No. 29/744,851, filed on Jul. 31, 2020, now Pat. No. D924723.

(51) Int. Cl. A63H 3/04; A63H 3/08; A63H 3/50

(52) U.S. Cl. CPC A63H 3/04; G09F 1/06; A63H 3/50; A63H 3/08

(57) ABSTRACT

A decoration system includes a base and a mount. The base has a base surface. A fixed portion of the mount is mounted to the base surface, and a moveable portion of the mount is movable between a folded position and an unfolded position. A decoration is mounted to the mount. The decoration is moveable between an erected position and an unerected position as the moveable portion moves between the folded position and the unfolded position. A slit is defined in the base. The base holds the decoration in the erected position upon receipt of at least a portion of the moveable portion within the slit.

### CROSS-REFERENCE TO RELATED APPLICATIONS

The present application is a continuation-in-part of U.S. patent application Ser. No. 29/744,851, entitled “Pop-up Figure” and filed on Jul. 31, 2020, which is specifically incorporated by reference herein in its entirety.

### FIELD

Aspects of the present disclosure relate generally to pop-up figures and more particularly to pop-up figures that move between an unerected and erected position.

### BACKGROUND

Many people enjoy collecting figures, such as toys, ornaments, figurines, statues, and/or the like. Often, such figures are prone to breaking, expensive, and difficult to store, among other drawbacks. Sending someone a figure as a gift can be particularly inconvenient, where the figure is typically packed using unsightly protective material into a package and shipped. Additionally, many children enjoy trading items and carrying the items around as they play and go places. Conventional figures are not well suited for trading, play, transport, or carrying. It is with these observations in mind, among others, that various aspects of the present disclosure were conceived and developed.

### SUMMARY

Implementations described and claimed herein address the foregoing problems by providing a decoration system. In one implementation, the decoration system includes a base and a mount. The base has a base surface. A fixed portion of the mount is mounted to the base surface, and a moveable portion of the mount is movable between a folded position and an unfolded position. A decoration is mounted to the mount. The decoration is moveable between an erected position and an unerected position as the moveable portion moves between the folded position and the unfolded position. A slit is defined in the base. The base holds the decoration in the erected position upon receipt of at least a portion of the moveable portion within the slit.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIGS. 1A and 1B are a top perspective view and a bottom perspective view, respectively, of an example pop-up figure of a decoration system.

FIGS. 2A and 2B are a top view and a bottom view, respectively, of the pop-up figure.

FIGS. 3A and 3B are a back perspective view and a front perspective view, respectively, of the pop-up figure.

FIG. 4 illustrates the pop-up figure in a storage position.

FIG. 5 shows a side view of the pop-up figure in the storage position.

FIG. 6 is a top view of the pop-up figure in the storage position.

FIG. 7 illustrates movement of the pop-up figure from the storage position to a display position.

FIG. 8 shows an example presentation system for the pop-up figure.

FIG. 9 illustrates example operations for moving a pop-up figure between the storage position and the display position.

FIG. 10 shows an example network environment that may implement an interactive interface in connection with the pop-up figures.

FIG. 11 is an example computing system that may implement various systems and methods discussed herein.

### DETAILED DESCRIPTION

Aspects of the presently disclosed technology relate to a decoration system. In one aspect, a pop-up figure of the decoration system includes a decoration and a base. The base is adapted for placement on a surface or holding by a user. A mount includes a fixed portion and a moveable portion. The fixed portion is mounted to the base, and the movable portion moves between an unfolded position and a folded position. A decoration is mounted to the mount at the fixed portion and the moveable portion. As such, when the movable portion is moved between the folded position and the unfolded position, the movement transfers to the decoration, which causes the decoration to move between an unerected position and an erected position. The base includes a slit to removably engage the movable portion to hold the decoration in the erected position. When the decoration is in the erected position and the movable portion is in the unfolded position, the pop-up figure is in the display position. On the other hand, when the decoration is in the unerected position and the movable portion is in the folded position, the pop-up figure is in the storage position. The pop-up figure may be made from paper and have various ornamental features. In some aspects, the decoration system includes a presentation system, such as a card, to transport, present, and/or store the pop-up figure. The presentation system may further include various ornamental features. Additionally, in some aspects, the pop-up figure and/or the presentation system may include a code or other identifier that may be utilized by an interactive interface of the decoration system to provide a corresponding digital experience.

The various systems and methods disclosed herein generally provide for a decoration system and methods related thereto. The example implementations discussed and illustrated herein reference a pop-up toy. However, it will be appreciated by those skilled in the art that the presently disclosed technology is applicable to other types of pop-up figures, including, but not limited to, ornaments, figurines, statutes, structures, and/or the like

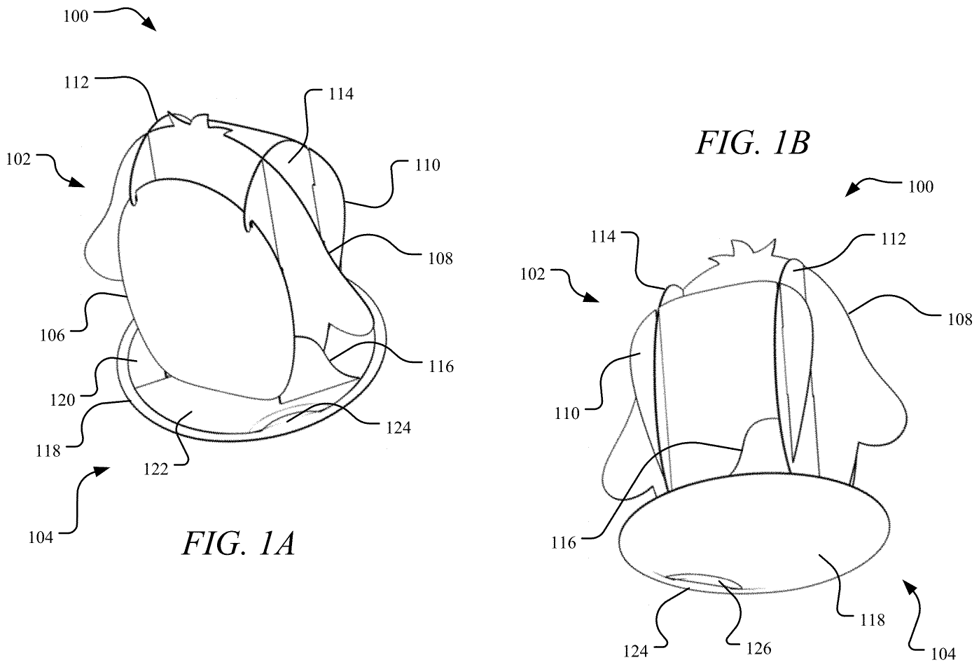

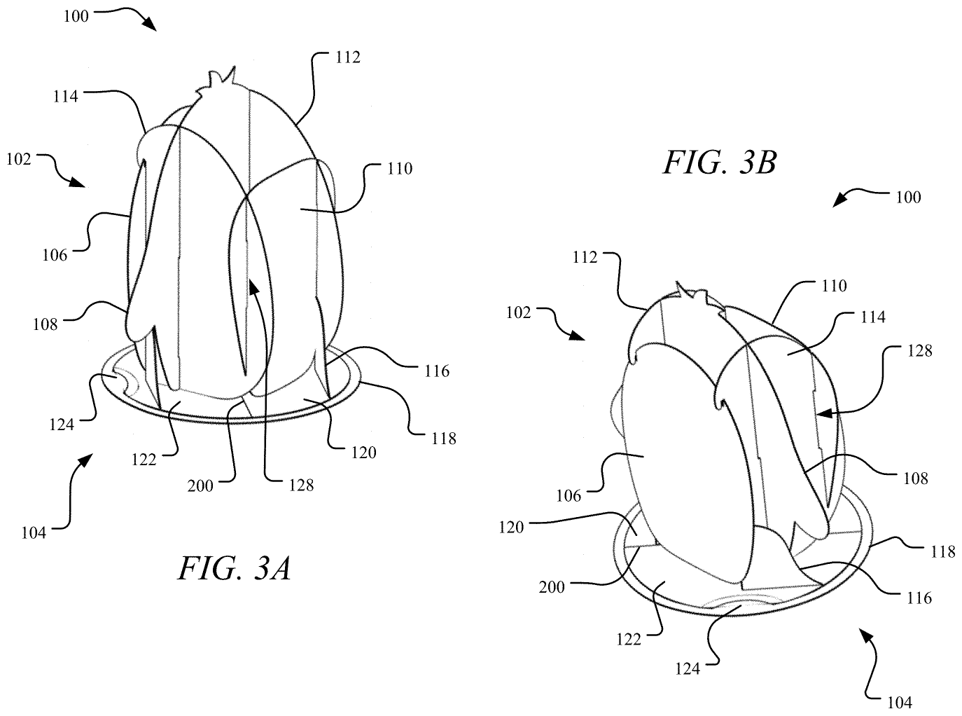

To begin a detailed description of an example pop-up figure 100 of a decoration system, reference is made to FIGS. 1A-3B. In one implementation, the pop-up figure 100 includes a decoration 102 and a stand 104. The pop-up figure 100 may be made entirely or predominantly from paper or a similar material. As detailed herein, the pop-up figure 100 moves between a display position and a storage position. In FIGS. 1A-3B, the pop-up figure 100 is illustrated in the display position.

In one implementation, the decoration 102 includes a plurality of panels that are interconnected and move relative to each other as the pop-up figure 100 moves between the display position and the storage position. As can be understood from FIGS. 1A-3B, in the display position, the decoration 102 is in an erected position, such that the decoration 102 forms a three-dimensional (3D) structure. In this example, the plurality of panels includes a first panel 106, a second panel 108, and a third panel 110 arranged in serial relationship. More particularly, when the decoration 102 is in the erected position, the panels 106-110 are layered behind each other and extending generally parallel to each other. For example, the second panel 108 may be a middle panel disposed between the first panel 106 as a front panel and the third panel 108 as a back panel.

The plurality of panels may further include a first side panel 112 and a second side panel 114 connecting the panels 106-110 to each other. When the decoration 102 is in the erected position, the first side panel 112 is disposed opposite the second side panel 114, and the side panels 112-114 extend generally transversely to the panels 106-110, thereby forming a decoration body of the decoration 102. Stated differently, in the erected position, the decoration 102 includes a plurality of panels that form the decoration body to create the 3D structure of the pop-up figure.

In one implementation, the decoration 102 is mounted to the stand 104 at one or more connection points using one or more connectors 116. More particularly, the stand 104 includes a base 118 and a mount formed by a fixed portion 120 and a movable portion 122. The connectors 116 may connect the decoration 102 to both the fixed portion 120 and the movable portion 122. For example, the decoration 102 may be mounted to the movable portion 122 at a first connection point using the connector 116, and the decoration 102 may be mounted to the fixed portion 120 at a second connection point using the connector 116.

The fixed portion 120 is mounted to the base 118, and the movable portion 122 is loose from the base 118. The movable portion 122 moves about an axis 202 can be understood from FIGS. 1A-3B, when the pop-up figure 100 is in the display position, the movable portion 122 is in the unfolded position. In one implementation, a slit 124 is defined in the base 118 to receive at least a portion 126 of the movable portion 122 to hold the movable portion 122 in the unfolded position, which holds the decoration 102 in the erected position. As such, the relationship of the slip 124 and the portion 126 maintains the pop-up figure 100 in the display position.

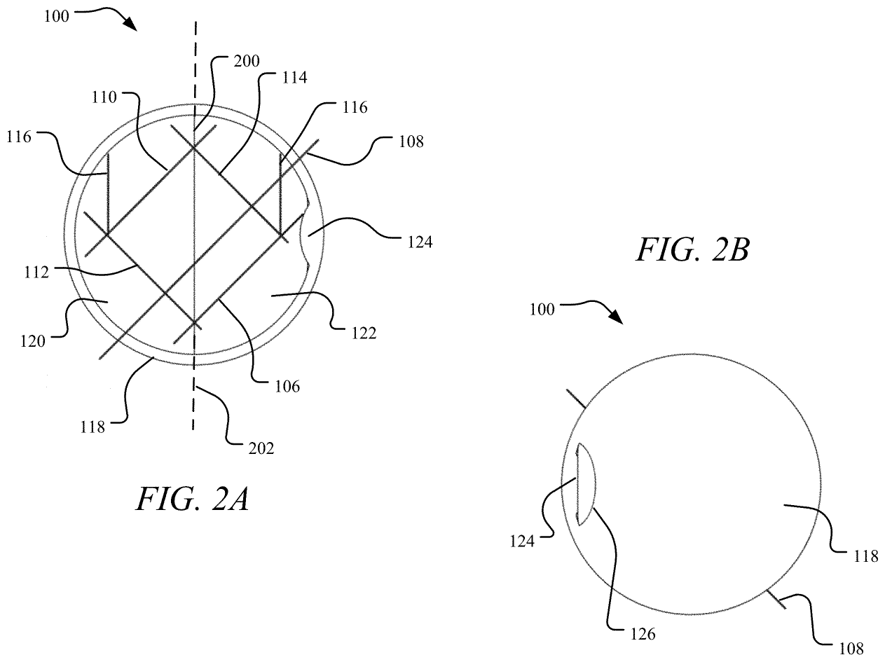

As shown in FIG. 2A, in one implementation, the decoration 102 is disposed at an offset orientation relative to the stand 104. In this offset orientation, the axis 202 defined by the fold line 200 separating the fixed portion 120 from the movable portion 122 extends at an angle relative to each of the panels 106-110 and each of the side panels 112-114. For example, the axis 202 may extend through a first intersection between the third panel 110 and the second side panel 114 and a second intersection between the first panel 106 and the first side panel 112. In this offset orientation, the connectors 116 may be oriented parallel to the axis 202.

Referring to FIGS. 1A-3B, the panels 106-110 and the side panels 112-114 are interconnected with each other using a set of tabs and openings. For example, the second side panel 114 may include an opening 128 through which a portion of the third panel 110 extends. The third panel 110 may have complementary opening above and below the opening 128 through which portions of the second side panel 114 extend. The top portion of the second side panel 114 may include a tab lock for securing the third panel 110 and the second side panel 114 with each other in a movable relationship. The panels 106-110 and side panels 112-114 may include various similar complementary openings and tabs to interconnect the plurality of panels of the decoration 102 in the movable relationship with each other.

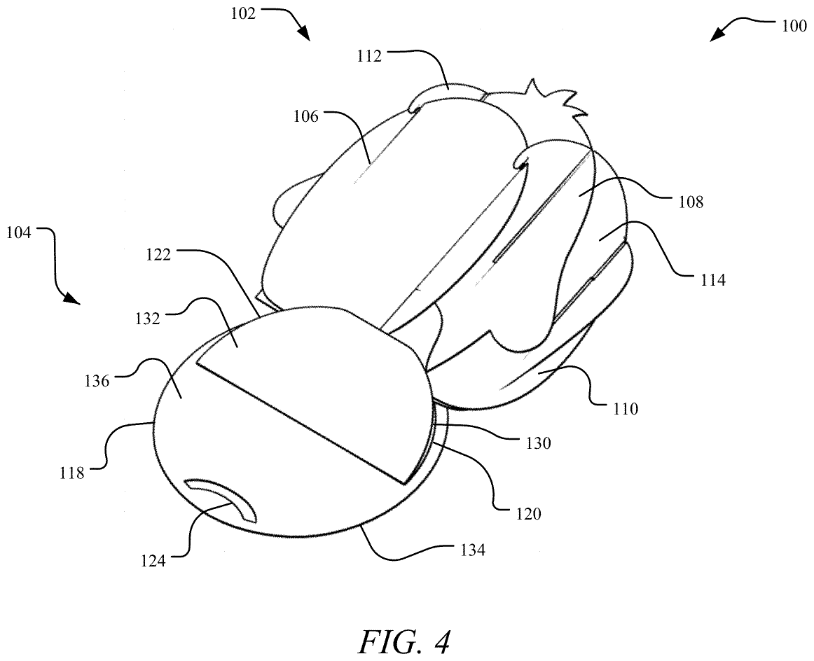

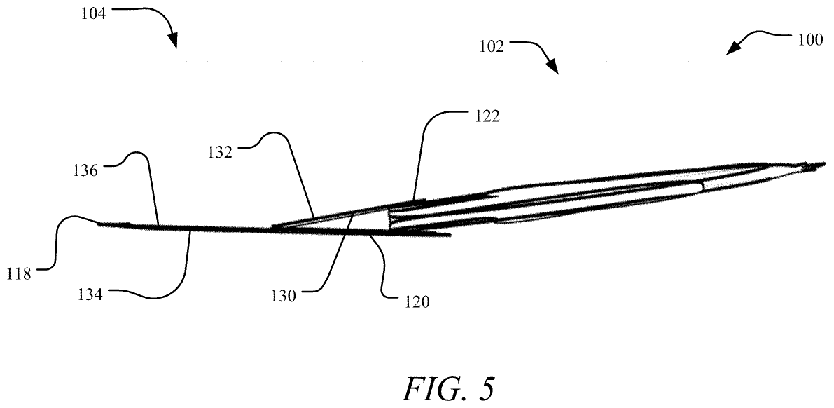

The movable relationship among the plurality of panels permits the decoration 102 to move to an unerected position as shown in FIGS. 4-6 when the movable portion 122 moves to the folded position. When the decoration 102 is in the unerected position and the movable portion 122 is in the folded position, the pop-up figure 100 is in the storage position. As shown in FIGS. 4-6, in the storage position, the pop-up figure 100 is generally flattened. The serial relationship of the panels 106-110 retains the panels 106-110 in the parallel orientation relative to each other. However, unlike in the erected position, when the decoration 102 is in the unerected position, the panels 106-110 are offset from each other. More particularly, as the decoration 102 moves from the erected position to the unerected position, the panels 106-110 displace relative to each other and the axis 202.

As described above, when the decoration 102 is in the erected position, the panels 106-110 are each oriented at an angle relative to the axis 202. Additionally, the panels 106-110 are layered behind each other in a parallel orientation relative to each other, such that the centers of the panels 106-110 are coaxial with each other. When the decoration 102 is in the unerected position, the panels 106-110 are in a parallel orientation relative to each other and to the axis 202, and the centers of the panels 106-110 are no longer coaxial with each other. For example, the first panel 106 is displaced in a first direction along the axis 202 relative to the second panel 108, and the third panel 110 is displaced in a second direction along the axis 202 relative to the second panel 108.

Similarly, when the decoration 102 is in the erected position, the side panels 112-114 are oriented at an angle relative to the axis 202, transverse to the panels 106-110, and parallel with each other. When the decoration 102 is in the unerected position, the side panels 112-114 are parallel with the axis 202 and the panels 106-110. Accordingly, in the unerected position, the decoration 102 is comprised of the plurality of panels layered on top of each other in a parallel orientation with each other and the axis 202 to form a generally flat structure.

In one implementation, the base 118 includes a first base surface 136 opposite a second base surface 134. The second base surface 134 may be adapted for placement on a flat surface, such as a table. The mount includes a first mount surface 130 disposed opposite a second mount surface 132. In one implementation, the second mount surface 132 is mounted to the first base surface 136 at the fixed portion 120, and the second mount surface 132 is loose from the first base surface 136 at the movable portion 122. Accordingly, the movable portion 122 is movable between the folded and unfolded position about the axis 202 extending along the fold line 200.

The decoration 102 is mounted to the first mount surface 130 at the one or more connection points using the one or more connectors 116. In one implementation, the decoration 102 is mounted to the first mount surface 130 at a first connection point and a second connection point. The first connection point is disposed on the fixed portion 120, and the second connection point is disposed on the movable portion 122. The first connection point transfers movement of the movable portion 122 to the decoration 104, such that the decoration 102 moves between erected position and the unerected position as the movable portion 122 moves between the folded position and the unfolded position.

As shown in FIGS. 1-6, when the movable portion 122 is in the folded position, the movable portion 122 is disposed adjacent to the fixed portion 120, and when the movable portion 122 is in the unfolded position, the movable portion 122 is disposed adjacent to the first base surface 136. In one implementation, the second mount surface 132 of the movable portion 122 is disposed adjacent to the first base surface 136 when the movable portion 122 is in the unfolded position, and the first mount surface 130 of the movable portion 122 is disposed adjacent to the first mount surface 130 of the fixed portion 120. The folded position may further include at least a portion of the decoration 102 in the unerected position and sandwiched between the fixed portion 120 and the movable portion 122 when the movable portion 122 is in the folded position. In this arrangement, at least a portion of the decoration 102 may be sandwiched between the first mount surface 130 of the fixed portion 120 and the first mount surface 132 of the movable portion 122.

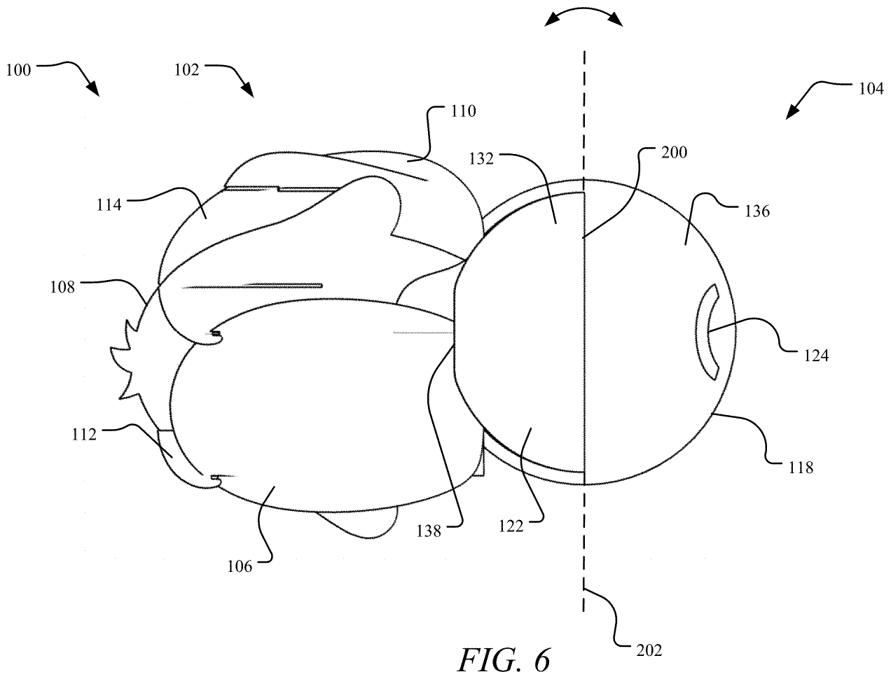

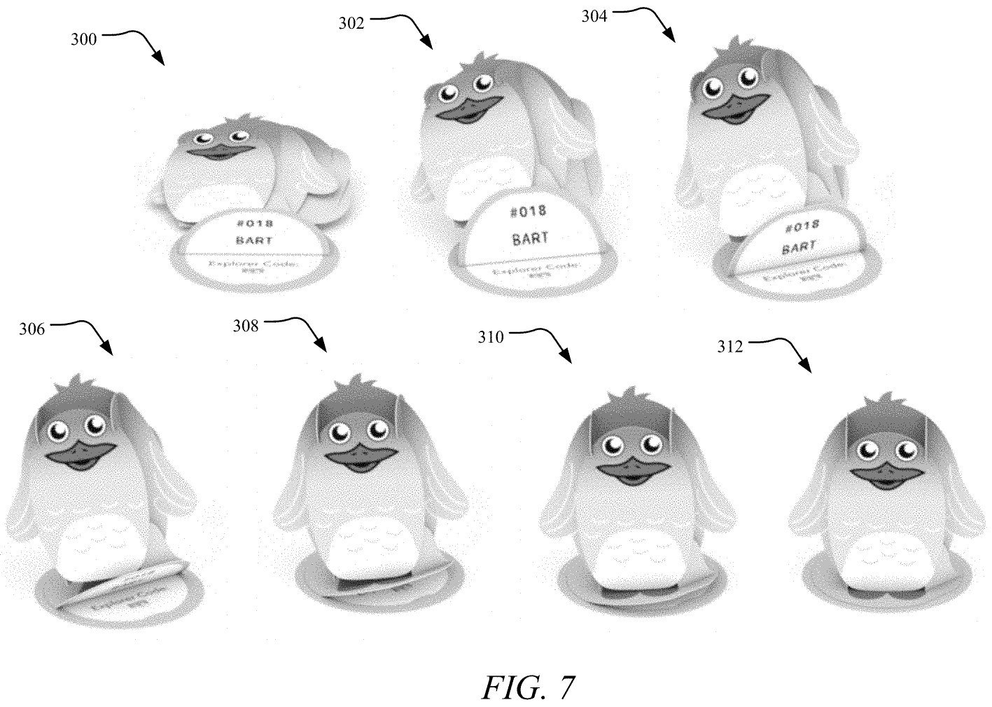

The decoration 102 is in the erected position when the movable portion 122 is in the unfolded position. As described herein, the slit 124 releasably engages the portion 126 of the movable portion 122 to hold the decoration 102 in the erected position and the movable portion 122 in the unfolded position. In one implementation, the slit 124 corresponds to a portion of the base 118 that is movable between a release position and a lock position. The release position disengages the portion 126 from the slit 124, and the lock position engages the portion 126 in the slit 124. In one implementation, the second base surface 134 corresponds to the portion of the base 118 and extends over the first mount surface 130 when the portion of the base 118 is in the lock position. Generally, the base 118 may overlap with the mount when the decoration 102 is held in the erected position using the slit 124. As shown in FIG. 6, the portion 126 of the movable portion 122 may include an insertion edge 138 that extends into and engages edges of the portion of the base 118 defining the slit 124. FIG. 7 illustrates an example transition sequence of positions 300-312 as the pop-up figure 100 moves from the storage position shown in first position 300 to the display position shown in the seventh position 312. It will be appreciated that the transition sequence is a non-limiting example to illustrate exemplary movement between the storage and display positions and there is not particular number of positions that occur therebetween.

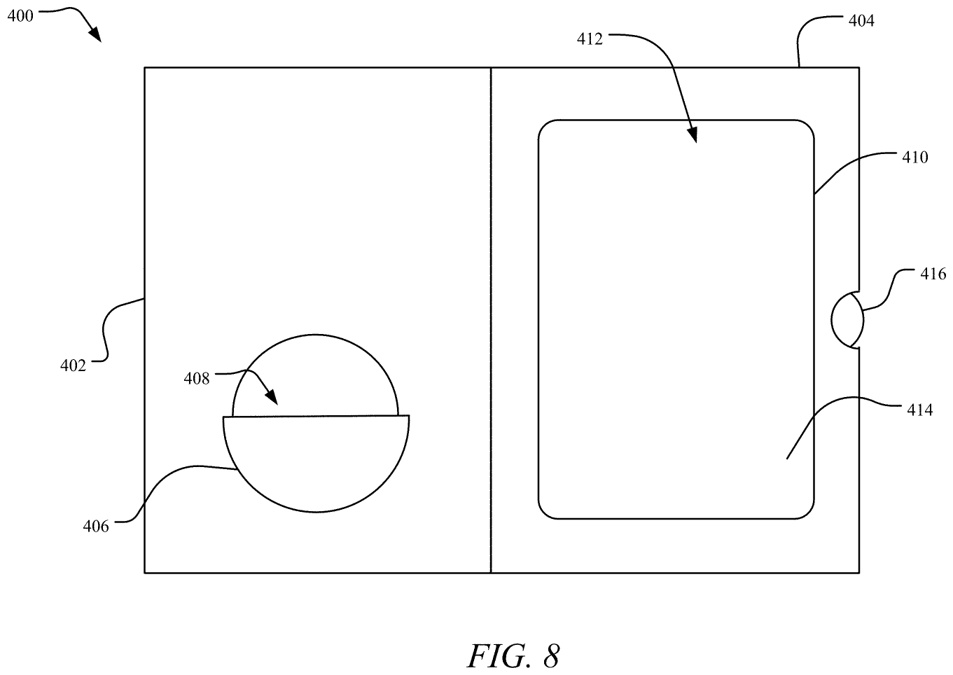

As can be understood from FIG. 8, in one implementation, the pop-up figure 100 may be deployed in a presentation system 400 for presenting the pop-up figure 100. In one implementation, the presentation system 400 is in the form of a card that includes a first card panel 402 and a second card panel 404. A pocket 406 may be formed in the first card panel 402 to create a receiving space 408 to hold and present the pop-up figure 100. In one implementation, the stand 104 is receivable in the receiving space 408 of the pocket 406 when the pop-up figure 100 is in the storage position. For example, the base 118 may be receivable in the receiving space 408 when the decoration 102 is in the unerected position and the movable portion 122 is in the folded position. The remainder of the pop-up figure 100 may extend outwardly from the pocket 406 against the first card panel 402 in the storage position to display the pop-up figure 100.

In one implementation, the second card panel 404 includes two panels, such as an inner panel and an outer panel layered over each other to define an insert pocket to receive an insert 414 such as a note, photograph, and/or the like. The inner panel may include an edge 410 defining a window 412 to view the insert 414. Further, the insert 414 may include a tab 416 to removing the insert 414 from the second card panel 404. It will be appreciated, however, that the pocket 406 may be formed in other presentation systems for storing and/or presenting the pop-up figure 100.

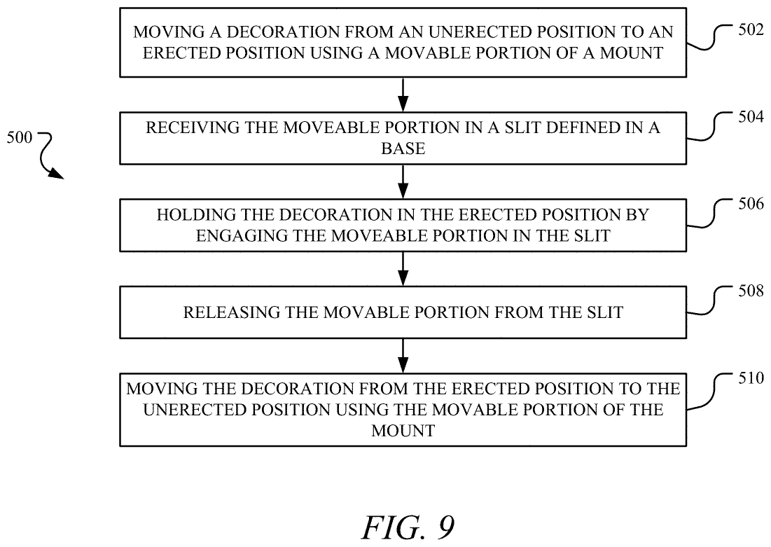

Turning to FIG. 9, example operations 500 for moving a pop-up figure between a storage position and a display position are illustrated. In one implementation, an operation 502 moves a decoration from an unerected position to an erected position using a movable portion of a mount, and an operation 504 receives the movable portion in a slit defined in a base. An operation 506 holds the decoration in the erected position by engaging the movable portion in the slit. An operation 508 releases the movable portion from the slit, and an operation 510 moves the decoration from the erected position to the unerected position using the movable portion of the mount.

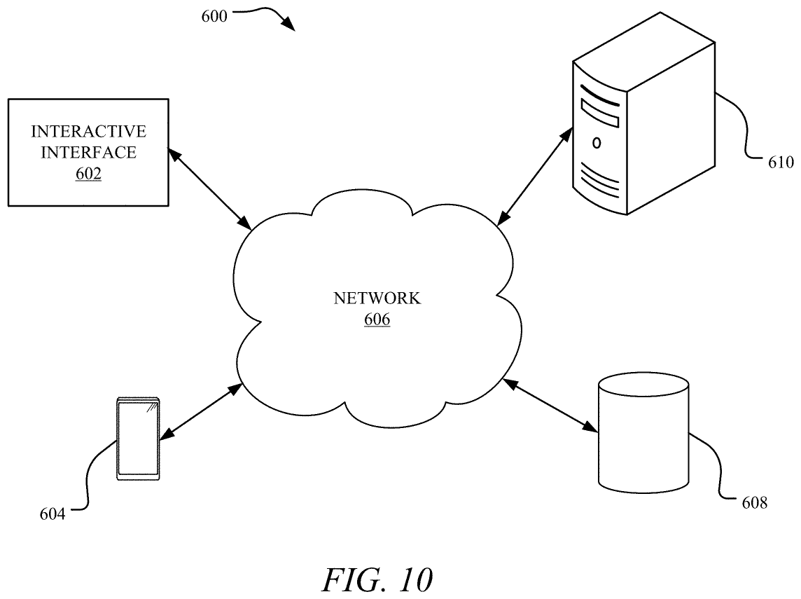

In some implementations, the pop-up figure 100 and/or the presentation system 400 may include an identifier, such as a barcode, alphanumeric code, graphic, QR code, and/or the like. Turning to FIG. 10, an example network environment 600 for implementing an interactive interface 602. As depicted in FIG. 10, a network 606 is used by one or more computing or data storage devices for implementing the interactive interface 602 for providing a corresponding digital environment for the pop-up figure 100 in which a user may interact with various digital elements. In one implementation, one or more user devices 604, one or more databases 608, and/or other network components or computing devices described herein are communicatively connected to the network 606. Examples of the user devices 604 include a terminal, personal computer, a smart-phone, a tablet, a mobile computer, a workstation, and/or the like.

A server 610 hosts the system. In one implementation, the server 610 also hosts a website or an application that users may visit to access the interactive interface 602. The server 610 may be one single server, a plurality of servers with each such server being a physical server or a virtual machine, or a collection of both physical servers and virtual machines. In another implementation, a cloud hosts one or more components of the system. The interactive interface 602, the user devices 604, the server 610, and other resources connected to the network 606 may access one or more additional servers for access to one or more websites, applications, web services interfaces, etc. that are used for interactive engagement. In one implementation, the server 610 also hosts a search engine that the system uses for accessing and modifying information, including without limitation, interactive activities, printable downloads, animated videos, and other interactive elements corresponding to the pop-up figures 100. Each pop-up figure 100 may include a unique identifier that the interactive interface 602 matches to a corresponding identifier that initiates various interactive elements associated with the particular pop-up figure 100. For example, each pop-up figure 100 may include a theme and/or back story that is accessible with interactive elements when the identifier is provided to the interactive interface 602. In one implementation, the user device 604 scans the identifier (e.g., a QR code) associated with the pop-up figure 100, which launches the interactive interface 602.

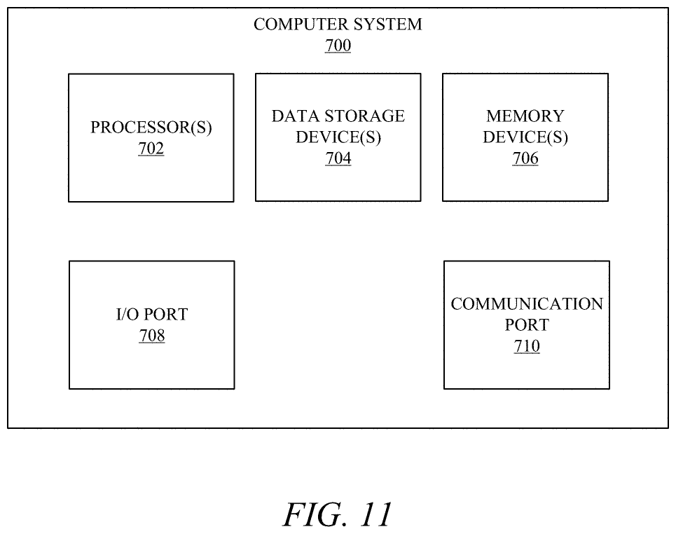

Referring to FIG. 11, a detailed description of an example computing system 700 having one or more computing units that may implement various systems and methods discussed herein is provided. The computing system 700 may be applicable to the interactive interface 602, the server 610, the user devices 604, and other computing or network devices. It will be appreciated that specific implementations of these devices may be of differing possible specific computing architectures not all of which are specifically discussed herein but will be understood by those of ordinary skill in the art.

The computer system 700 may be a computing system is capable of executing a computer program product to execute a computer process. Data and program files may be input to the computer system 700, which reads the files and executes the programs therein. Some of the elements of the computer system 700 are shown in FIG. 11, including one or more hardware processors 702, one or more data storage devices 704, one or more memory devices 708, and/or one or more ports 708-710. Additionally, other elements that will be recognized by those skilled in the art may be included in the computing system 700 but are not explicitly depicted in FIG. 11 or discussed further herein. Various elements of the computer system 700 may communicate with one another by way of one or more communication buses, point-to-point communication paths, or other communication means not explicitly depicted in FIG. 11.

The processor 702 may include, for example, a central processing unit (CPU), a microprocessor, a microcontroller, a digital signal processor (DSP), and/or one or more internal levels of cache. There may be one or more processors 702, such that the processor 702 comprises a single central-processing unit, or a plurality of processing units capable of executing instructions and performing operations in parallel with each other, commonly referred to as a parallel processing environment.

The computer system 700 may be a conventional computer, a distributed computer, or any other type of computer, such as one or more external computers made available via a cloud computing architecture. The presently described technology is optionally implemented in software stored on the data stored device(s) 704, stored on the memory device(s) 706, and/or communicated via one or more of the ports 708-710, thereby transforming the computer system 700 in FIG. 11 to a special purpose machine for implementing the operations described herein. Examples of the computer system 700 include personal computers, terminals, workstations, mobile phones, tablets, laptops, personal computers, multimedia consoles, gaming consoles, set top boxes, and the like.

The one or more data storage devices 704 may include any non-volatile data storage device capable of storing data generated or employed within the computing system 700, such as computer executable instructions for performing a computer process, which may include instructions of both application programs and an operating system (OS) that manages the various components of the computing system 700. The data storage devices 704 may include, without limitation, magnetic disk drives, optical disk drives, solid state drives (SSDs), flash drives, and the like. The data storage devices 704 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 706 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 704 and/or the memory devices 706, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 700 includes one or more ports, such as an input/output (I/O) port 708 and a communication port 710, for communicating with other computing, network, or vehicle devices. It will be appreciated that the ports 708-710 may be combined or separate and that more or fewer ports may be included in the computer system 700.

The I/O port 708 may be connected to an I/O device, or other device, by which information is input to or output from the computing system 700. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 700 via the I/O port 708. Similarly, the output devices may convert electrical signals received from computing system 700 via the I/O port 708 into signals that may be sensed as output by a human, such as sound, light, and/or touch. The input device may be an alphanumeric input device, including alphanumeric and other keys for communicating information and/or command selections to the processor 702 via the I/O port 708. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 700 via the I/O port 708. For example, an electrical signal generated within the computing system 700 may be converted to another type of signal, and/or vice-versa. In one implementation, the environment transducer devices sense characteristics or aspects of an environment local to or remote from the computing device 700, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 700, such as, physical movement of some object (e.g., a mechanical actuator), heating or cooling of a substance, adding a chemical substance, and/or the like.

In one implementation, a communication port 710 is connected to a network by way of which the computer system 700 may receive network data useful in executing the methods and systems set out herein as well as transmitting information and network configuration changes determined thereby. Stated differently, the communication port 710 connects the computer system 700 to one or more communication interface devices configured to transmit and/or receive information between the computing system 700 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 710 to communicate one or more other machines, either directly over a point-to-point communication path, over a wide area network (WAN) (e.g., the Internet), over a local area network (LAN), over a cellular (e.g., third generation (3G) or fourth generation (4G)) network, or over another communication means. Further, the communication port 710 may communicate with an antenna or other link for electromagnetic signal transmission and/or reception.

In an example implementation, the pop-up figure information, interactive information and elements, software and other modules and services may be embodied by instructions stored on the data storage devices 704 and/or the memory devices 706 and executed by the processor 702.

The system set forth in FIG. 11 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A decorative system comprising:
a base having a first base surface disposed opposite a second base surface;
a mount having a first mount surface disposed opposite a second mount surface, the mount having an axis separating a fixed portion from a moveable portion, the second mount surface mounted to the first base surface at the fixed portion, the moveable portion moveable about the axis between a folded position and an unfolded position;
a decoration mounted to the first mount surface, the decoration moveable between an erected position and an unerected position as the moveable portion moves between the folded position and the unfolded position; and
a slit defined in the base, the base holding the decoration in the erected position upon receipt of at least a portion of the moveable portion within the slit.

2. The decorative system of claim 1, wherein the slit corresponds to a portion of the base, the portion moveable between a release position and a lock position, the release position disengaging the moveable portion from the slit and the lock position engaging the movable portion in the slit.

3. The decorative system of claim 1, wherein the second base surface corresponding to the portion of the base extends over the first mount surface of the movable portion when the portion is in the lock position.

4. The decorative system of claim 1, wherein the base overlaps with the mount when the decoration is held in the erected position using the slit.

5. The decorative system of claim 1, wherein the decoration is mounted to the first surface at a first connection point and a second connection point.

6. The decorative system of claim 6, wherein the first connection point is disposed on the fixed portion and the second connection point is disposed on the moveable portion.

7. The decorative system of claim 1, wherein the unfolded position includes the second mount surface of the movable portion being disposed adjacent to the first base surface and the folded position includes the first mount surface of the movable portion being disposed adjacent to the first mount surface of the fixed portion.

8. The decorative system of claim 7, wherein the folded position includes at least a portion of the decoration being sandwiched in the unerected position between the first mount surface of the fixed portion and the first mount surface of the movable portion.

9. A decorative system comprising:
a base having a base surface;
a fixed portion of a mount, the fixed portion mounted to the base surface;
a moveable portion of the mount, the moveable portion movable between a folded position and an unfolded position;
a decoration mounted to the mount, the decoration moveable between an erected position and an unerected position as the moveable portion moves between the folded position and the unfolded position; and
a slit defined in the base, the base holding the decoration in the erected position upon receipt of at least a portion of the moveable portion within the slit.

10. The decorative system of claim 9, wherein the decoration is mounted to the mount at a first connection point and a second connection point, the first connection point disposed on the fixed portion and the second connection point disposed on the movable portion.

11. The decorative system of claim 9, wherein the decoration is sandwiched between the fixed portion and the movable portion when the decoration is in the unerected position and the movable portion is in the folded position.

12. The decorative system of claim 9, wherein the base overlaps with the movable portion when the decoration is held in the erected position using the slit.

13. The decorative system of claim 9, wherein the slit corresponds to a portion of the base, the portion moveable between a release position and a lock position, the release position disengaging the moveable portion from the slit and the lock position engaging the movable portion in the slit.

14. A decorative system comprising:
a base having a base surface;
a fixed portion of a mount, the fixed portion mounted to the base surface;
a moveable portion of the mount, the moveable portion movable between a folded position and an unfolded position;
a decoration mounted to the movable portion at a first connection point and to the fixed portion at a second connection point, the first connection point transferring movement of the movable portion to the decoration, such that the decoration moves between an erected position and an unerected position as the moveable portion moves between the folded position and the unfolded position; and
a slit defined in the base, the base holding the decoration in the erected position upon receipt of at least a portion of the moveable portion within the slit.

15. The decorative system of claim 14, wherein the slit corresponds to a portion of the base, the portion moveable between a release position and a lock position, the release position disengaging the moveable portion from the slit and the lock position engaging the movable portion in the slit.

16. The decorative system of claim 14, wherein the base overlaps with the movable portion when the decoration is held in the erected position using the slit.

17. The decorative system of claim 14, wherein the unfolded position includes the movable portion being disposed adjacent to the base surface and the folded position includes the movable portion being disposed adjacent to the fixed portion.

18. The decorative system of claim 17, wherein the decoration is sandwiched between the fixed portion and the movable portion when the decoration is in the unerected position and the movable portion is in the folded position.

19. The decorative system of claim 14, wherein the base is receivable in a pocket when the decoration is in the unerected position and the movable portion is in the folded position.

20. The decorative system of claim 19, wherein the pocket is formed on a card.
